(19) United States
(12) Patent Application Publication
(10) Pub. No.: US 2026/0183712 A1
(43) Pub. Date: Jul. 2, 2026

(54) EXHAUST GAS PURIFYING DEVICE

(71) Applicant: SUBARU CORPORATION, Tokyo (JP)

(72) Inventor: Norio SUGIURA, Tokyo (JP)

(21) Appl. No.: 19/419,850

(22) Filed: Dec. 15, 2025

(30) Foreign Application Priority Data
Dec. 27, 2024 (JP) 2024-233044

(51) Int. Cl. B01D 53/94

(52) U.S. Cl. CPC B01D 53/9454; B01D 53/9495

(57) ABSTRACT

An exhaust gas purifying device includes an exhaust gas purifying catalyst and a heat exchanger. The exhaust gas purifying catalyst is provided in an exhaust pipe of an engine and is configured to purify an exhaust gas discharged from the engine. The heat exchanger is configured to divert a part of the exhaust gas from the exhaust pipe, to guide the part of the exhaust gas to an outer peripheral portion of the exhaust gas purifying catalyst, and to perform heat exchange between the exhaust gas and the outer peripheral portion of the exhaust gas purifying catalyst.

### CROSS-REFERENCE TO RELATED APPLICATIONS

The present application claims priority from Japanese Patent Application No. 2024-233044 filed on Dec. 27, 2024, the entire contents of which are hereby incorporated by reference.

The disclosure relates to an exhaust gas purifying device including an exhaust gas purifying catalyst that purifies an exhaust gas of an engine.

To date, rapid warm-up (temperature-increasing) control of an exhaust gas purifying catalyst, which purifies an exhaust gas of an engine, has been performed in order to rapidly activate the exhaust gas purifying catalyst and to reduce exhaust gas emission after starting (immediately after starting) the engine. In the rapid warm-up (temperature-increasing) control, the temperature of the exhaust gas purifying catalyst is increased by using, for example, so-called afterburning that occurs due to delay (retardation) of an ignition timing (see, for example, Japanese Unexamined Patent Application Publication No. 2008-190428).

### SUMMARY

An aspect of the disclosure provides an exhaust gas purifying device including an exhaust gas purifying catalyst and a heat exchanger. The exhaust gas purifying catalyst is provided in an exhaust pipe of an engine and is configured to purify an exhaust gas discharged from the engine. The heat exchanger is configured to divert a part of the exhaust gas from the exhaust pipe, to guide the part of the exhaust gas to an outer peripheral portion of the exhaust gas purifying catalyst, and to perform heat exchange between the exhaust gas and the outer peripheral portion of the exhaust gas purifying catalyst.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 illustrates the configuration of an engine including an exhaust gas purifying device according to an embodiment of the disclosure;

FIG. 2 illustrates the configuration of the exhaust gas purifying device according to the embodiment;

FIG. 3 illustrates the function (operation) of the exhaust gas purifying device according to the embodiment; and

FIG. 4 illustrates the configuration of an exhaust gas purifying device according to a modification.

### DETAILED DESCRIPTION

The flow of an exhaust gas in an exhaust pipe is not even (uniform), and, for example, the exhaust gas flow rate in an outer peripheral portion of an exhaust gas purifying catalyst may be less than that in a middle portion (central portion). In such a case, temperature increase of the outer peripheral portion of the exhaust gas purifying catalyst may be slower than that of the middle portion (central portion), and activation may be delayed. That is, the timing when the entirety of the exhaust gas purifying catalyst is activated (the purification ratio reaches 100%) may be delayed.

It is desirable to provide an exhaust gas purifying device that is capable of accelerating temperature increase (activation) of an outer peripheral portion of an exhaust gas purifying catalyst and thereby promoting rapid activation of the entirety of the exhaust gas purifying catalyst (that is, more rapidly making the purification ratio of the exhaust gas purifying catalyst be 100%).

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

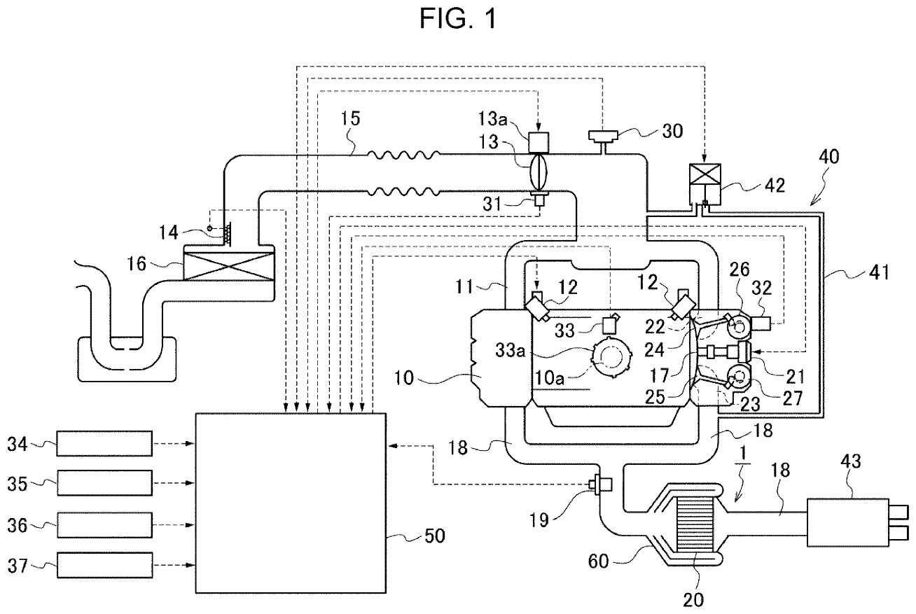

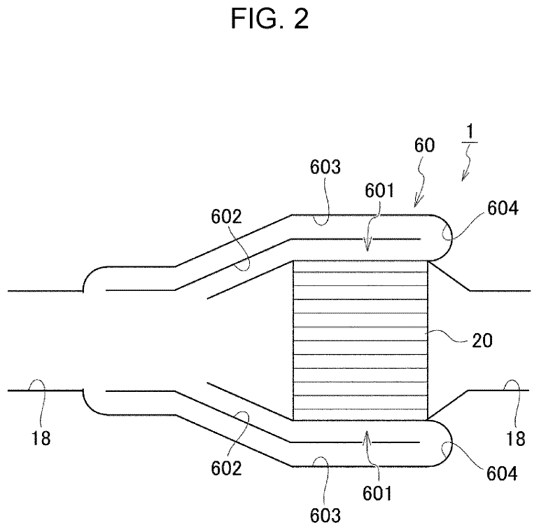

First, referring to FIG. 1 and FIG. 2, the configuration of an exhaust gas purifying device 1 according to the embodiment will be described. FIG. 1 illustrates the configuration of an engine 10 to which the exhaust gas purifying device 1 is applied. FIG. 2 illustrates the configuration of the exhaust gas purifying device 1.

The engine 10, which may be of any type, is, for example, a horizontally-opposed four-cylinder gasoline engine. The engine 10 is an in-cylinder injection engine that directly injects a fuel into a cylinder. In the engine 10, air drawn from an air cleaner 16 is squeezed by an electronic control throttle valve (hereafter, simply referred to as “throttle valve”) 13 provided in an intake pipe 15, passes through an intake manifold 11, and is drawn into each cylinder formed in the engine 10.

Here, the flow rate of air drawn from the air cleaner 16 is detected by an airflow meter 14 that is disposed between the air cleaner 16 and the throttle valve 13. In a collector portion (surge tank) of the intake manifold 11, a vacuum sensor 30 that detects the pressure in the intake manifold 11 (intake manifold pressure) is disposed. Moreover, on the throttle valve 13, a throttle opening degree sensor 31 that detects the opening degree of the throttle valve 13 is disposed.

In a cylinder head, an intake port 22 and an exhaust port 23 are formed for each cylinder (only one bank is illustrated in FIG. 1). In the intake port 22 and the exhaust port 23, respectively, an intake valve 24 and an exhaust valve 25 that open and close the intake port 22 and the exhaust port 23 are provided. A variable valve timing mechanism 26 is disposed between an intake cam shaft and an intake cam pulley that drive the intake valve 24. The variable valve timing mechanism 26 advances and retards the valve timing (opening/closing timing) of the intake valve 24 by rotating the intake cam pulley and the intake cam shaft relative to each other and continuously changing the rotation phase (displacement angle) of the intake cam shaft relative to a crank shaft 10a. The opening/closing timing of the intake valve 24 is variably set by the variable valve timing mechanism 26 in accordance with an engine operation status.

Likewise, a variable valve timing mechanism 27 is disposed between an exhaust cam shaft and an exhaust cam pulley. The variable valve timing mechanism 27 advances and retards the valve timing (opening/closing timing) of the exhaust valve 25 by rotating the exhaust cam pulley and the exhaust cam shaft relative to each other and continuously changing the rotation phase (displacement angle) of the exhaust cam shaft relative to the crank shaft 10a. The opening/closing timing of the exhaust valve 25 is variably set by the variable valve timing mechanism 27 in accordance with an engine operation status.

An injector 12 that injects a fuel into a cylinder is attached to each cylinder of the engine 10. The injector 12 directly injects a fuel that has been pressurized by a high-pressure fuel pump (not shown) into the combustion chamber of each cylinder.

An ignition plug 17 that ignites an air-fuel mixture and an ignitor built-in coil 21 that applies a high voltage to the ignition plug 17 are attached to the cylinder head of each cylinder. In each cylinder of the engine 10, a mixture gas of intake air and a fuel injected by the injector 12 is ignited by the ignition plug 17 and burns. The exhaust gas after burning is discharged through an exhaust pipe 18.

An air-fuel ratio sensor 19 is attached downstream of a merging portion of the exhaust pipe 18 and upstream of an exhaust gas purifying catalyst 20. As the air-fuel ratio sensor 19, a linear air-fuel ratio sensor (LAF sensor) is used. The LAF sensor can output a signal in accordance with the oxygen concentration and the unburnt gas concentration in an exhaust gas (that is, a signal in accordance with the air-fuel ratio of an air-fuel mixture gas) and can linearly detect the air-fuel ratio.

The exhaust gas purifying catalyst 20 is disposed downstream of the LAF sensor 19. The exhaust gas purifying catalyst 20 is, for example, a three-way catalyst. The exhaust gas purifying catalyst 20 simultaneously performs oxidation of hydrocarbons (HC) and carbon monoxide (CO) and reduction of nitrogen oxides (NOₓ) in an exhaust gas to purify noxious gas components in the exhaust gas into carbon dioxide (CO₂), water vapor (H₂O), and nitrogen (N₂), which are innoxious. The exhaust gas purifying catalyst 20 performs the catalyst function by having a temperature higher than or equal to a predetermined activation temperature. A silencer (muffler) 43 that reduces exhaust sound is attached to the downstream side of the exhaust gas purifying catalyst 20.

In the exhaust pipe 18, an exhaust gas recirculation device (hereafter, referred to as “EGR device”) 40, which recirculates a part of the exhaust gas discharged from the engine 10 to the intake manifold 11 of the engine 10, is provided. The EGR device 40 includes EGR piping 41 that connects the exhaust pipe 18 to the intake manifold 11 of the engine 10 and an EGR valve 42 that is disposed in the EGR piping 41 and adjusts the exhaust gas recirculation rate (EGR flow rate). The opening degree (EGRSTP) of the EGR valve 42 is controlled by an electronic control unit 50 (described below) in accordance with the driving status of the engine 10.

In addition to the airflow meter 14, the LAF sensor 19, the vacuum sensor 30, and the throttle opening degree sensor 31 described above, a cam angle sensor 32 for performing cylinder determination of the engine 10 is attached to the vicinity of the cam shaft of the engine 10. A crank angle sensor 33 that detects the rotation position of the crank shaft 10a is attached to the vicinity of the crank shaft 10a of the engine 10. Here, for example, a timing rotor 33a, in which thirty-four teeth are formed at 10° intervals with two missing teeth, is attached to an end of the crank shaft 10a. The crank angle sensor 33 detects the rotation position of the crank shaft 10a by detecting the presence and absence of the teeth of the timing rotor 33a. As the cam angle sensor 32 and the crank angle sensor 33, for example, electromagnetic pickup sensors or the like are used.

These sensors are connected to an electronic control unit (hereafter, referred to as “ECU”) 50. Moreover, various sensors such as a water temperature sensor 34 that detects the temperature of cooling water of the engine 10, an oil temperature sensor 35 that detect the temperature of a lubricating oil, an accelerator sensor 36 that detects the depression amount of an accelerator pedal, that is, the operation amount of an accelerator, and a vehicle velocity sensor 37 that detects the velocity of the vehicle are connected to the ECU 50.

The ECU 50 includes a microprocessor that performs calculations, an EEPROM that stores programs for causing the microprocessor to perform each processing, a RAM that stores various data such as calculation results, a backup RAM whose stored contents are retained by a battery or the like, an input-output I/F, and the like. The ECU 50 further includes an injector driver that drives the injector 12, an output circuit that outputs an ignition signal, a motor driver that drives an electric motor 13a that opens and closes the electronically-controlled throttle valve 13, and the like.

The ECU 50 determines a cylinder from the output of the cam angle sensor 32, and calculates the rotational angular velocity and the engine rotational speed from the output of the crank angle sensor 33. The ECU 50 acquires, based on detection signals that are input from the various sensors described above, various information items such as the intake air amount, the intake pipe negative pressure, the accelerator operation amount, the air-fuel ratio of a mixture gas, and the water temperature and the oil temperature of the engine 10. Based on the acquired various information items, the ECU 50 comprehensively controls the engine 10 by controlling the fuel injection amount, the ignition timing, and various devices such as the throttle valve 13 and the EGR valve 42.

Immediately after the engine is started, the ECU 50 performs rapid warm-up (temperature-increasing) of the exhaust gas purifying catalyst 20 by using so-called afterburning, which occurs due to retardation (IG retardation) of the ignition timing, in order to rapidly activate the exhaust gas purifying catalyst 20.

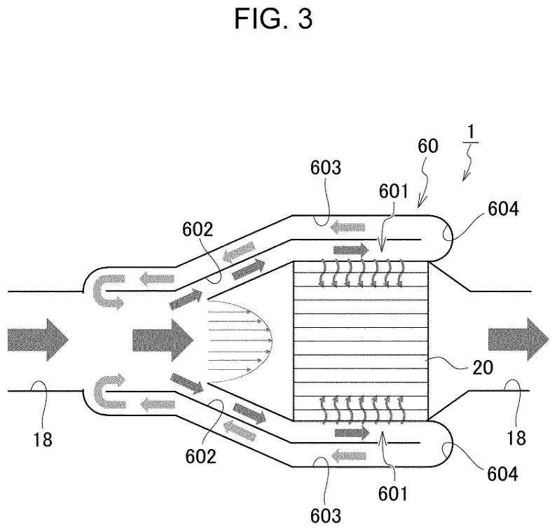

As described above, the flow of an exhaust gas in the exhaust pipe 18 is not even (uniform), and, for example, the exhaust gas flow rate in an outer peripheral portion of the exhaust gas purifying catalyst 20 may be less than that in a middle portion (central portion) (see FIG. 3). In such a case (if left alone), temperature increase of the outer peripheral portion of the exhaust gas purifying catalyst 20 may be slower than that of the middle portion (central portion), and activation may be delayed. That is, the timing when the entirety of the exhaust gas purifying catalyst 20 is activated (the purification ratio reaches 100%) may be delayed.

Thus, the exhaust gas purifying device 1 including the exhaust gas purifying catalyst 20 has the function of accelerating temperature increase (activation) of an outer peripheral portion of the exhaust gas purifying catalyst 20 and thereby promoting rapid activation of the entirety of the exhaust gas purifying catalyst 20 (that is, more rapidly making the purification ratio of the exhaust gas purifying catalyst 20 be 100%).

Therefore, the exhaust gas purifying device 1 includes a heat exchanger 60 that diverts a part of an exhaust gas from the exhaust pipe 18, guides (draws) the part of the exhaust gas to an outer peripheral portion (outer peripheral surface) of the exhaust gas purifying catalyst 20, and performs heat exchange between the exhaust gas and the outer peripheral portion of the exhaust gas purifying catalyst 20.

The heat exchanger 60 is configured, for example, to divert a part of the exhaust gas from the exhaust pipe 18 on the upstream side of the exhaust gas purifying catalyst 20, to guide the part of the exhaust gas to an outer peripheral portion of the exhaust gas purifying catalyst 20, to perform heat exchange between the exhaust gas and the outer peripheral portion of the exhaust gas purifying catalyst 20, and to return the exhaust gas after heat exchange to the exhaust pipe 18 on the upstream side of the exhaust gas purifying catalyst 20.

For example, as illustrated in FIG. 2, the heat exchanger 60 mainly includes: a heat exchange member 601 that is disposed outside of the exhaust gas purifying catalyst 20 in such a way as to cover an outer peripheral portion of the exhaust gas purifying catalyst 20 and performs heat exchange between the exhaust gas and the outer peripheral portion of the exhaust gas purifying catalyst 20; a supply pipe 602 that diverts a part of the exhaust gas from the exhaust pipe 18 on the upstream side of the exhaust gas purifying catalyst 20 and guides the part of the exhaust gas to the heat exchange member 601; a return pipe 603 that returns (heat-exchanged) exhaust gas on which heat exchange has been performed in the heat exchange member 601 to the exhaust pipe 18 on the upstream side of the exhaust gas purifying catalyst 20; and a turnaround pipe 604 that connects (couples) the heat exchange member 601 to the return pipe 603.

The heat exchange member 601 has, for example, a hollow cylindrical shape, and is disposed outside of the exhaust gas purifying catalyst 20, which has a substantially solid cylindrical shape, in such a way as to cover the outer peripheral portion of the exhaust gas purifying catalyst 20. The heat exchange member 601 performs heat exchange between the exhaust gas and the outer peripheral portion of the exhaust gas purifying catalyst 20.

The supply pipe 602 has, for example, a hollow and bottomless substantially truncated-cone shape in accordance with the shape (outer shape) of the exhaust pipe 18, and is disposed outside of the exhaust pipe 18 in such a way as to cover the outer peripheral surface of the exhaust pipe 18. A first end (open end) of the supply pipe 602 is connected (coupled) to the exhaust pipe 18 on the upstream side of the exhaust gas purifying catalyst 20, and a second end (open end) of the supply pipe 602 is connected (coupled) to a first end (open end) of the heat exchange member 601. The supply pipe 602 guides (draws) a part of the exhaust gas from the exhaust pipe 18 to the heat exchange member 601.

The return pipe 603 has, for example, a shape in accordance with the shapes (outer shapes) of the supply pipe 602 and the heat exchange member 601, and is disposed outside of the supply pipe 602 and the heat exchange member 601 in such a way as to cover the outer peripheral surfaces of the supply pipe 602 and the heat exchange member 601. A first end (open end) the return pipe 603 is connected (coupled) to the exhaust pipe 18 on the upstream side of the exhaust gas purifying catalyst 20. The return pipe 603 returns (recirculates) the exhaust gas after heat exchange to the exhaust pipe 18. Here, the exhaust gas after heat exchange is returned to the exhaust pipe 18 by using, for example, a negative pressure generated by the Venturi effect.

The turnaround pipe 604 has, for example, a substantially U-shaped cross section along the axial direction and connects a second end (open end) of the heat exchange member 601 to a second end (open end) of the return pipe 603. The turnaround pipe 604 turns around the exhaust gas after heat exchange and sends the exhaust gas to the return pipe 603.

The heat exchanger 60 described above is made of, for example, a stainless-steel material or the like that is the same as the material of the exhaust pipe 18. The heat exchanger 60 is manufactured by, for example, first, covering the outside (from the outside) of the exhaust pipe 18 and the exhaust gas purifying catalyst 20 with the supply pipe 602 and the heat exchange member 601 to be coupled (joined), and, next, covering the outside (from the outside) of the supply pipe 602 and the heat exchange member 601 with the return pipe 603 and the turnaround pipe 604 to be coupled (joined). For example, a perforated mesh or the like may be used (in terms of strength) for the connection portion (inlet) of the supply pipe 602 and the exhaust pipe 18 and the connection portion (outlet) of the return pipe 603 and the exhaust pipe 18. The cross-sectional area (passage area) of each pipe of the heat exchanger 60 may be set in consideration of, for example, temperature-increasing conditions of the exhaust gas purifying catalyst 20, exhaust efficiency, and the like.

With the configuration described above, for example, as illustrated in FIG. 3, a part of the exhaust gas is diverted from the exhaust pipe 18 on the upstream side of the exhaust gas purifying catalyst 20 and guided (drawn) to an outer peripheral portion of the exhaust gas purifying catalyst 20, and heat exchange is performed between the exhaust gas and the outer peripheral portion of the exhaust gas purifying catalyst 20. Therefore, temperature increase (activation) of the outer peripheral portion of the exhaust gas purifying catalyst 20 is accelerated when the engine is started (cold started).

The exhaust gas after heat exchange is returned to the exhaust pipe 18 on the upstream side of the exhaust gas purifying catalyst 20. The exhaust gas after heat exchange returned to the exhaust pipe 18 is purified by the exhaust gas purifying catalyst 20 and then discharged to the outside.

As described above in detail, according the present embodiment, a part of the exhaust gas is diverted from the exhaust pipe 18 and guided (drawn) to an outer peripheral portion of the exhaust gas purifying catalyst 20, and heat exchange is performed between the exhaust gas and the outer peripheral portion of the exhaust gas purifying catalyst 20. Therefore, temperature increase of the outer peripheral portion of the exhaust gas purifying catalyst 20 can be accelerated when the engine is started (cold started), and it is possible to promote rapid activation of the outer peripheral portion of the exhaust gas purifying catalyst 20.

As a result, temperature increase (activation) of the outer peripheral portion of the exhaust gas purifying catalyst 20 can be accelerated, and thereby it becomes possible to promote rapid activation of the entirety of the exhaust gas purifying catalyst 20 (that is, to more rapidly make the purification ratio of the exhaust gas purifying catalyst 20 be 100%).

With the present embodiment, for example, compared with when a dedicated device such as an electric heating catalyst (EHC) is added, it is possible to more rapidly increase the temperature of the exhaust gas purifying catalyst 20 with a lower cost and a simpler configuration.

According the present embodiment, a part of the exhaust gas is diverted from the exhaust pipe 18 on the upstream side of the exhaust gas purifying catalyst 20 and guided to an outer peripheral portion of the exhaust gas purifying catalyst 20, heat exchange is performed between the exhaust gas and the outer peripheral portion of the exhaust gas purifying catalyst 20, and the exhaust gas after heat exchange is returned to the exhaust pipe 18 on the upstream side of the exhaust gas purifying catalyst 20. Therefore, without using external motive power, it is possible to return the exhaust gas after heat exchange to the exhaust pipe 18 by using a negative pressure generated by the Venturi effect. Moreover, it is possible to purify the exhaust gas after heat exchange that has been returned to the exhaust pipe 18 by the exhaust gas purifying catalyst 20 and then to discharge the discharge gas.

According the present embodiment, the heat exchange member 601 has a hollow cylindrical shape and is disposed outside of the exhaust gas purifying catalyst 20, which has a substantially solid cylindrical shape, in such a way as to cover an outer peripheral portion of the exhaust gas purifying catalyst 20; the supply pipe 602 has a hollow and bottomless substantially truncated-cone shape and is disposed outside of the exhaust pipe 18 in such a way as to cover the outer peripheral surface of the exhaust pipe 18; a first end of the supply pipe 602 is connected to the exhaust pipe 18 on the upstream side of the exhaust gas purifying catalyst 20, and a second end of the supply pipe 602 is connected to a first end of the heat exchange member 601; the return pipe 603 is disposed outside of the supply pipe 602 and the heat exchange member 601 in such a way as to cover outer peripheral surfaces of the supply pipe 602 and the heat exchange member 601, and a first end of the return pipe 603 is connected to the exhaust pipe 18 on the upstream side of the exhaust gas purifying catalyst 20; and the turnaround pipe 604 has a substantially U-shaped cross section along the axial direction and connects a second end of the heat exchange member 601 to a second end of the return pipe 603. Therefore, it is possible to divert a part of the exhaust gas from the exhaust pipe 18 on the upstream side of the exhaust gas purifying catalyst 20, to guide the part of the exhaust gas to the heat exchange member 601, to perform heat exchange between the exhaust gas and the outer peripheral portion of the exhaust gas purifying catalyst 20, and to return the exhaust gas after heat exchange to the exhaust pipe 18 on the upstream side of the exhaust gas purifying catalyst 20.

### Modification

In the embodiment described above, a part of the exhaust gas is diverted (drawn) from the exhaust pipe 18 on the upstream side of the exhaust gas purifying catalyst 20, and the exhaust gas after heat exchange is returned to the exhaust pipe 18 on the upstream side of the exhaust gas purifying catalyst 20. However, a part of the exhaust gas may be diverted (drawn) from the exhaust pipe 18 on the downstream side of the exhaust gas purifying catalyst 20, and the exhaust gas after heat exchange may be returned to the exhaust pipe 18 on the downstream side of the exhaust gas purifying catalyst 20.

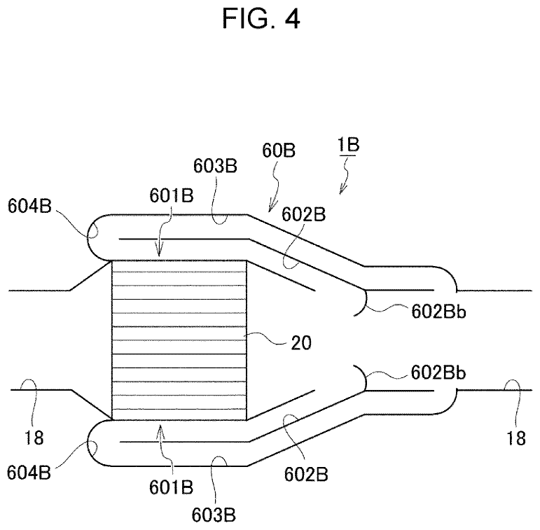

Next, referring to FIG. 4, the configuration of an exhaust gas purifying device 1B according to a modification will be described. FIG. 4 illustrates the configuration of the exhaust gas purifying device 1B according to the modification. In FIG. 4, constituent elements that are the same as those of the embodiment described above are denoted by the same numerals.

A heat exchanger 60B of the exhaust gas purifying device 1B is configured, for example, to divert a part of the exhaust gas from the exhaust pipe 18 on the downstream side of the exhaust gas purifying catalyst 20, to guide the part of the exhaust gas to an outer peripheral portion of the exhaust gas purifying catalyst 20, to perform heat exchange between the exhaust gas and the outer peripheral portion of the exhaust gas purifying catalyst 20, and to return the exhaust gas after heat exchange to the exhaust pipe 18 on the downstream side of the exhaust gas purifying catalyst 20.

For example, the heat exchanger 60B mainly includes: a heat exchange member 601B that is disposed outside of the exhaust gas purifying catalyst 20 in such a way as to cover an outer peripheral portion of the exhaust gas purifying catalyst 20 and performs heat exchange between the exhaust gas and the outer peripheral portion of the exhaust gas purifying catalyst 20; a supply pipe 602B that diverts a part of the exhaust gas from the exhaust pipe 18 on the downstream side of the exhaust gas purifying catalyst 20 and guides the part of the exhaust gas to the heat exchange member 601B; a return pipe 603B that returns (heat-exchanged) exhaust gas on which heat exchange has been performed in the heat exchange member 601B to the exhaust pipe 18 on the downstream side of the exhaust gas purifying catalyst 20; and a turnaround pipe 604B that connects (couples) the heat exchange member 601B to the return pipe 603B.

The heat exchange member 601B has, for example, a hollow cylindrical shape, and is disposed outside of the exhaust gas purifying catalyst 20, which has a substantially solid cylindrical shape, in such a way as to cover the outer peripheral portion of the exhaust gas purifying catalyst 20. The heat exchange member 601B performs heat exchange between the exhaust gas and the outer peripheral portion of the exhaust gas purifying catalyst 20.

The supply pipe 602B has, for example, a hollow and bottomless substantially truncated-cone shape, and is disposed outside of the exhaust pipe 18 in such a way as to cover the outer peripheral surface of the exhaust pipe 18. A first end (open end) of the supply pipe 602B is connected (coupled) to the exhaust pipe 18 on the downstream side of the exhaust gas purifying catalyst 20, and a second end (open end) of the supply pipe 602B is connected (coupled) to a first end (open end) of the heat exchange member 601B. The supply pipe 602B guides (draws) a part of the exhaust gas from the exhaust pipe 18 to the heat exchange member 601B.

Here, in order to change the direction of the flow of the exhaust gas, for example, a barb 602Bb, that is, a projection or the like that is annular when seen from the axial direction, may be formed so as to protrude inward in the radial direction at the coupling portion between the exhaust pipe 18 and the supply pipe 602B (portion through which the exhaust gas is drawn).

The return pipe 603B is disposed outside of the supply pipe 602B and the heat exchange member 601B in such a way as to cover the outer peripheral surfaces of the supply pipe 602B and the heat exchange member 601B. A first end (open end) the return pipe 603B is connected (coupled) to the exhaust pipe 18 on the downstream side of the exhaust gas purifying catalyst 20. The return pipe 603B returns (recirculates) the exhaust gas after heat exchange to the exhaust pipe 18. Here, the exhaust gas after heat exchange is returned to the exhaust pipe 18 by using, for example, a negative pressure generated by the Venturi effect.

The turnaround pipe 604B has, for example, a substantially U-shaped cross section along the axial direction and connects a second end (open end) of the heat exchange member 601B to a second end (open end) of the return pipe 603B. The turnaround pipe 604B turns around the exhaust gas after heat exchange and sends the exhaust gas to the return pipe 603B.

Detailed descriptions of the other configurations, which are the same as or similar to those of the embodiment described above, will be omitted here.

According to the present modification, a part of the exhaust gas is diverted from the exhaust pipe 18 on the downstream side of the exhaust gas purifying catalyst 20 and guided (drawn) to an outer peripheral portion of the exhaust gas purifying catalyst 20, and heat exchange is performed between the exhaust gas and the outer peripheral portion of the exhaust gas purifying catalyst 20. The exhaust gas after heat exchange is returned to the exhaust pipe 18 on the downstream side of the exhaust gas purifying catalyst 20. Therefore, as with the embodiment described above, temperature increase of the outer peripheral portion of the exhaust gas purifying catalyst 20 can be accelerated when the engine is started (cold started), and it is possible to promote rapid activation of the outer peripheral portion of the exhaust gas purifying catalyst 20. As a result, temperature increase (activation) of the outer peripheral portion of the exhaust gas purifying catalyst 20 can be accelerated, and thereby it becomes possible to promote rapid activation of the entirety of the exhaust gas purifying catalyst 20 (that is, to more rapidly make the purification ratio of the exhaust gas purifying catalyst 20 be 100%).

With the present modification, because it is possible to increase the temperature of the outer peripheral portion of the exhaust gas purifying catalyst 20 again by using the exhaust gas (waste heat) that has been used to increase the temperature of the exhaust gas purifying catalyst 20, it becomes possible to recover the waste heat.

Heretofore, an embodiment of the disclosure has been described. However, the disclosure is not limited to the embodiment described above, and can be modified in various ways. For example, although an example in which the exhaust gas purifying catalyst 20 is a three-way catalyst has been described in the embodiment, the exhaust gas purifying catalyst 20 is not limited to a three-way catalyst as long as temperature increase is necessary for activation, and may be, for example, a diesel oxidation catalyst (DOC), a lean NOx trap (LNT) catalyst, or the like.

Dimensions, materials, values, and the like in the embodiment described above are examples for ease of understanding the disclosure, and do not limit the disclosure unless otherwise noted.

In the embodiment described above, an example in which the disclosure is applied to the horizontally-opposed engine 10 has been described. However, the disclosure is applicable not only to a horizontally-opposed engine but also to an in-line engine, a V-type engine, and the like. Moreover, the disclosure is applicable not only to an engine vehicle whose driving source is only an engine but also to a hybrid vehicle (HEV) whose driving source includes an engine and an electric motor.

With an exhaust gas purifying device according to an aspect of the disclosure, a part of the exhaust gas is diverted from an exhaust pipe and guided to an outer peripheral portion of an exhaust gas purifying catalyst, and heat exchange is performed between the exhaust gas and the outer peripheral portion of the exhaust gas purifying catalyst. Therefore, temperature increase of the outer peripheral portion of an exhaust gas purifying catalyst can be accelerated, and it is possible to promote rapid activation of the outer peripheral portion of the exhaust gas purifying catalyst.

With the disclosure, temperature increase (activation) of an outer peripheral portion of an exhaust gas purifying catalyst can be accelerated, and thereby it is possible to promote rapid activation of the entirety of the exhaust gas purifying catalyst (that is, to more rapidly make the purification ratio of the exhaust gas purifying catalyst be 100%).

1. An exhaust gas purifying device comprising:
an exhaust gas purifying catalyst that is provided in an exhaust pipe of an engine and is configured to purify an exhaust gas discharged from the engine; and
a heat exchanger that is configured to divert a part of the exhaust gas from the exhaust pipe, to guide the part of the exhaust gas to an outer peripheral portion of the exhaust gas purifying catalyst, and to perform heat exchange between the exhaust gas and the outer peripheral portion of the exhaust gas purifying catalyst.

2. The exhaust gas purifying device according to claim 1, wherein the heat exchanger is configured to divert the part of the exhaust gas from the exhaust pipe on an upstream side of the exhaust gas purifying catalyst, to guide the part of the exhaust gas to the outer peripheral portion of the exhaust gas purifying catalyst, to perform the heat exchange between the exhaust gas and the outer peripheral portion of the exhaust gas purifying catalyst, and to return the exhaust gas after heat exchange to the exhaust pipe on the upstream side of the exhaust gas purifying catalyst.

3. The exhaust gas purifying device according to claim 2, wherein the heat exchanger comprises
a heat exchange member that is disposed outside of the exhaust gas purifying catalyst in such a way as to cover the outer peripheral portion of the exhaust gas purifying catalyst and is configured to perform the heat exchange between the exhaust gas and the outer peripheral portion of the exhaust gas purifying catalyst, and
a supply pipe that is configured to divert the part of the exhaust gas from the exhaust pipe on the upstream side of the exhaust gas purifying catalyst and to guide the part of the exhaust gas to the heat exchange member,
a return pipe that is configured to return the exhaust gas on which heat exchange has been performed in the heat exchange member to the exhaust pipe on the upstream side of the exhaust gas purifying catalyst, and
a turnaround pipe that is configured to connect the heat exchange member to the return pipe and to send the exhaust gas after heat exchange to the return pipe.

4. The exhaust gas purifying device according to claim 3,
wherein the heat exchange member has a hollow cylindrical shape and is disposed outside of the exhaust gas purifying catalyst, which has a substantially solid cylindrical shape, in such a way as to cover the outer peripheral portion of the exhaust gas purifying catalyst,
wherein the supply pipe has a hollow cylindrical shape or a hollow and bottomless substantially truncated-cone shape and is disposed outside of the exhaust pipe in such a way as to cover the outer peripheral surface of the exhaust pipe, a first end of the supply pipe is connected to the exhaust pipe on the upstream side of the exhaust gas purifying catalyst, and a second end of the supply pipe is connected to a first end of the heat exchange member,
wherein the return pipe is disposed outside of the supply pipe and the heat exchange member in such a way as to cover the outer peripheral surface of the supply pipe and an outer peripheral surface of the heat exchange member, and a first end of the return pipe is connected to the exhaust pipe on the upstream side of the exhaust gas purifying catalyst, and
wherein the turnaround pipe has a substantially U-shaped cross section along an axial direction and connects a second end of the heat exchange member to a second end of the return pipe.

5. The exhaust gas purifying device according to claim 1, wherein the heat exchanger is configured to divert the part of the exhaust gas from the exhaust pipe on a downstream side of the exhaust gas purifying catalyst, to guide the part of the exhaust gas to the outer peripheral portion of the exhaust gas purifying catalyst, to perform the heat exchange between the exhaust gas and the outer peripheral portion of the exhaust gas purifying catalyst, and to return the exhaust gas after heat exchange to the exhaust pipe on the downstream side of the exhaust gas purifying catalyst.
